(19) United States
(12) Patent Application Publication
(10) Pub. No.: US 2017/0001615 A1
(43) Pub. Date: Jan. 5, 2017

(54) CALIBRATION METHOD FOR AN ELECTRO-HYDRAULIC MOTOR VEHICLE BRAKING SYSTEM AND ASSOCIATED CALIBRATION DEVICE

(71) Applicant: LUCAS AUTOMOTIVE GMBH, Koblenz (DE)

(72) Inventors: Vanessa Adler, Niederwerth (DE); Kay Schlafke, Hahnstaetten (DE); Niko Naether, Nastaetten (DE); Karlheinz Schaust, Fachbach (DE)

(73) Assignee: Lucas Automotive GmbH, Koblenz (DE)

(21) Appl. No.: 15/125,829

(22) PCT Filed: Dec. 12, 2014
(86) PCT No.: PCT/EP2014/077496

§ 371 Date: Sep. 13, 2016

(30) Foreign Application Priority Data
Mar. 14, 2014 (DE) 10 2014 003 641.3

(51) Int. Cl. B60T 13/66; B60T 13/74; B60T 13/68; B60T 7/04

(52) U.S. Cl. CPC B60T 13/662; B60T 7/042; B60T 13/745; B60T 13/686; B60T 2270/82

(57) ABSTRACT

A calibration method is specified for an electro-hydraulic motor vehicle brake system. The brake system comprises a piston for building up a hydraulic pressure in the brake system, a first actuator having an electric motor, and a second actuator having a brake pedal interface. The first actuator and the second actuator are both capable of activating the piston, wherein a first sensor system detects a change in state of the first actuator, and a second sensor system detects a change in state of the second actuator. The calibration method starts with actuation of the electric motor, in order to activate the piston by means of the first actuator, wherein the second actuator follows the piston activation. During the piston activation, a first signal which is generated by the first sensor system and which permits a conclusion to be drawn about an extent of the piston activation, as well as a second signal which is generated by the second sensor system are detected. Subsequently, the first signal is calibrated on the basis of the second signal, or vice versa.

### CROSS-REFERENCE TO RELATED APPLICATIONS

This application is the National Phase of International Application PCT/EP2014/077496 filed Dec. 12, 2014 which designated the U.S. and that International Application was published on Sep. 17, 2015 as International Publication Number WO 2015/135608 A1. PCT/EP2014/077496 claims priority to German Patent Application No. 10 2014 003 641.3, filed Mar. 14, 2014. Thus, the subject nonprovisional application claims priority to German Patent Application No. 10 2014 003 641.3, filed Mar. 14, 2014. The disclosures of both applications are incorporated herein by reference.

### BACKGROUND OF THE INVENTION

The invention relates generally to the field of electro-hydraulic motor vehicle brake systems. Specifically, a calibration method for the sensor system installed in such a brake system is specified.

DE 10 2011 116 167 A1 discloses an electro-hydraulic motor vehicle brake system which comprises a master cylinder assembly with a master cylinder and a piston which is displaceably accommodated therein. Activation of the piston brings about a change in brake pressure (for example a buildup in brake pressure) to wheel brakes which are fluidically coupled to the master cylinder.

In order to activate the piston, two actuators are provided which are capable of acting on an input-side end face of the piston. The first actuator comprises an electric motor and a transmission which is connected downstream thereof and has the purpose of changing the brake pressure within the scope of a “brake-by-wire”, BBW, operation. The second actuator permits mechanical “engagement” with the piston in an emergency braking mode of the brake system. For this purpose, the second actuator has a brake pedal interface so that a force applied to the brake pedal can be applied directly to the piston via a rod-shaped activation element. In contrast, in the regular BBW mode the brake pedal is decoupled from the piston.

In order to decouple the brake pedal from the piston, a gap is provided in a force transmission path between the brake pedal and the piston. The gap is maintained while the piston is shifted by means of the first actuator, and the rod-shaped activation element of the second actuator lags in relation to the piston under the influence of the brake pedal movement.

In order to be able to ensure reliable BBW mode, it is highly significant that the gap always has a sufficient width. The gap width must be large enough to be able to react quickly also to dynamic pedal activations, but without the activation element coming into force-transmitting abutment against the piston.

In order to maintain the gap in the force transmission path between the brake pedal and the piston, changes in state of the second actuator are determined in the BBW mode by means of a sensor system. To be more precise, the position dependent on the extent of pedal activation, of a component of the second actuator (or of the brake pedal) is detected continuously by sensor. On the basis of the position detection, the electric motor of the first actuator is then actuated in such a way that by shifting the piston the required brake pressure is generated and at the same time a sufficient gap width can be maintained.

It goes without saying that the reliability of this position detection has a large influence on the functional reliability of the brake system in the BBW mode. For this reason, the functional capability—and in particular the accuracy—of the sensor system which is used for the position detection is of outstanding significance. Since, in addition, maintaining a sufficient gap width requires actuation of the electric motor, the sensor system which is present for the first actuator (for example for actuation purposes or checking purposes) must also satisfy extremely high accuracy requirements.

Of course, accuracy requirements made of the sensor system of the brake system under consideration here apply quite generally and are not restricted to the maintenance of a sufficient gap width which is mentioned here by way of example.

### SUMMARY OF THE INVENTION

A calibration method for the sensor system of an electro-hydraulic motor vehicle brake system is to be specified, which calibration method ensures sufficient accuracy of a signal which is generated by the sensor system. In addition, a corresponding calibration device is to be specified.

According to one aspect, a calibration method is specified for an electro-hydraulic motor vehicle brake system which comprises a piston for building up a hydraulic pressure in the brake system, a first actuator having an electric motor and a second actuator having a brake pedal interface. The first actuator and the second actuator are capable of activating the piston, wherein a first sensor system is capable of detecting a change in state of the first actuator, and a second sensor system is capable of detecting a change in state of the second actuator. The calibration method comprises actuating the electric motor in order to activate the piston by means of the first actuator, wherein to the second actuator follows the piston activation, detecting, during the piston activation, a first signal which is generated by the first sensor system and permits a conclusion to be drawn about an extent of the piston activation, as well as a second signal which is generated by the second sensor system, and calibrating the first signal on the basis of the second signal, or vice versa.

Any sensor system can comprise one or more sensors. Each sensor can in turn have a single-part or multi-part design. It is therefore possible for a travel sensor to contain, for example, two parts which are movable relative to one another. Furthermore, a signal-conditioning circuit or a signal-evaluation circuit can be included in each sensor system.

During the actuation of the electric motor, an auxiliary force can be applied to the second actuator, under which auxiliary force the second actuator follows the piston activation. Such a procedure can be expedient when the second actuator is or can be coupled only loosely to the piston (for example bears against the latter) but also in other cases. The auxiliary force can be applied, for example, to a brake pedal interface or to a component of the second actuator (for example a brake pedal) which is coupled to the brake pedal interface.

The brake system can be capable of being operated in a BBW mode or some other mode (for example a brake boosting mode). In the BBW mode, a gap is provided or can be provided in a force transmission path between the pedal interface and the piston, in order to decouple the second actuator from the piston. The gap can be overcome or formation of the gap can be prevented by means of the auxiliary force applied to the second actuator.

Generally, the second sensor system can be capable of detecting a change in state of part of the second actuator which part is located on a side of the gap located opposite the piston. For example, the second sensor system can be capable of detecting a change in state of the brake pedal interface or of a component of the second actuator (for example the brake pedal) which is coupled thereto.

It is to be noted that the provision of a gap is an optional feature and does not need to be provided, for example, in a brake boosting mode of the brake system. In the brake boosting mode, an activation force which is applied to the piston by the driver by means of the second actuator is boosted by means of the first actuator. In other words, in this mode both the first actuator and the second actuator act simultaneously on the piston.

During the piston activation, a change in the second signal can be deleted. The calibration of the second signal can in this context relate the change in the second signal to the extent of the piston activation specified by the first signal (and therefore to the extent of the activation of the second actuator following the piston). Generally, the extent of the piston activation can be specified by travel carried out by the piston (and the second actuator following the latter).

The first signal can have an essentially linear characteristic. It is therefore possible for there to be a linear dependence of a level of the first signal on the extent of the piston activation (for example on the travel carried out by the piston). The second signal can have an essentially non-linear characteristic. It is therefore possible for there to be a non-linear dependence of a level of the second signal on the extent of the piston activation.

Generally, the second signal can be calibrated on the basis of the first signal. It is therefore possible for the level of the second signal to be related to the extent of the piston activation specified by the level of the first signal. If the extent of the piston activation is specified, for example, in the form of travel carried out by the piston (and of the second actuator following it), a specific level of the second signal can be related to the travel carried out and therefore calibrated therewith.

The piston can have a maximum stroke (for example structurally conditioned). In such a case, the electric motor can be actuated so that the piston essentially executes the maximum stroke. The electric motor can therefore be actuated, for example, in such a way that the piston executes 70% or more of the maximum stroke.

The first signal and the second signal can be detected while the electric motor is actuated in two opposing directions. In this way, a hysteresis or some other effect can be taken into account within the scope of the calibration. For example, the calibration can be carried out separately for opposing activation directions of the piston.

The electric motor can be a brushless motor. However, other implementations of electric motor are also conceivable.

The first sensor system can detect a change in state of the electric motor (for example a rotational angle of the electric motor which has been passed through or a number of revolutions of the electric motor which have been carried out). Alternatively or additionally to this, the first sensor system can detect a change in state of a transmission component which is included in the first actuator and is functionally provided between the electric motor and the piston. The change in state of the transmission component can be given, for example, by a rotational angle which is passed through, a number of revolutions which are carried out or the length of a transitional movement.

The change in state which is detected by the first sensor system can generally be converted into travel which is carried out by the piston (or second actuator following the latter). Calibration of the second signal can then be carried out on the basis of the travel carried out.

Different embodiments, which can be combined with one another, are conceivable with respect to the second sensor system.

According to a first variant, the second sensor system comprises at least one travel sensor, wherein this travel sensor is calibrated. The travel sensor can comprise at least one of the following elements: a Hall sensor, a magnet and a potentiometer. The travel sensor can be configured to detect actuation travel of the second actuator or of a part of the second actuator. For example, the second actuator can comprise a brake pedal, and the travel sensor can be configured to detect actuation travel of the brake pedal.

According to a further variant, the second sensor system can comprise at least one pressure sensor (for example in addition to a travel sensor), wherein the pressure sensor is calibrated. If the second actuator comprises a hydraulic circuit, the pressure sensor can, for example, be designed to detect a hydraulic pressure in the hydraulic circuit of the second actuator.

According to a third variant, the second sensor system can comprise at least one force sensor (for example in addition to a travel sensor and/or a pressure sensor), wherein the force sensor is calibrated. The force sensor can be designed to detect a force which is applied to the brake pedal interface by a driver. The force is applied to the brake pedal interface by the driver by means of the brake pedal.

The calibration method can be carried out before the brake system is installed in a motor vehicle. For example, the calibration method can be part of an end-of-line test. Additionally or alternatively to this, the calibration method can be carried out in a state of the brake system which is devoid of hydraulic fluid. However, it would also be conceivable to carry out the calibration method in the installed state of the brake system.

A computer program having program code for carrying out the calibration method presented here when the computer program is executed by a computer device is also provided. The computer device can be embodied as a control unit (electronic control unit, ECU) or a diagnostic unit. In addition, the computer program can be stored on a computer-readable storage medium, for example a CD-ROM, DVD or a semiconductor memory.

According to a further aspect, a calibration device for an electro-hydraulic motor vehicle brake system is specified, which calibration device comprises a piston for building up a hydraulic pressure in the brake system, a first actuator having an electric motor and a second actuator having a brake pedal interface. The first actuator and the second actuator are capable of activating the piston, wherein a first sensor system is capable of detecting a change in state of the first actuator, and a second sensor system is capable of detecting a change in state of the second actuator. The device comprises an actuation unit which is designed to actuate the electric motor in order to activate the piston by means of the first actuator, wherein the second actuator follows the piston activation. The calibration device also comprises a detection unit which is designed to detect, during the piston activation, a first signal which is generated by the first sensor system and permits a conclusion to be drawn about an extent of the piston activation, as well as a second signal which is generated by the second sensor system. The calibration device also comprises a calibration apparatus which is designed to calibrate the first signal on the basis of the second signal, or vice versa.

Various aspects of this invention will become apparent to those skilled in the art from the following detailed description of the preferred embodiment, when read in light of the accompanying drawings.

### BRIEF DESCRIPTION OF THE DRAWINGS

FIGS. 1A and 1B show a first and a second exemplary embodiment of an electro-hydraulic motor vehicle brake system;

FIG. 2 shows a third exemplary embodiment of an electro-hydraulic motor vehicle brake system;

FIG. 3A shows a schematic view of the non-activated basic position of the brake system according to one of FIGS. 1A and 2;

FIG. 3B shows a schematic view of the actuation position of the brake system according to one of FIGS. 1A and 2;

FIGS. 4A and 4B show schematic diagrams which illustrate by way of example the dependence of a gap length on brake pedal travel;

FIG. 5 shows an exemplary embodiment of a calibration device;

FIG. 6 shows a flowchart which illustrates an exemplary embodiment of a calibration method; and

FIG. 7 shows a calibrated characteristic curve profile of Hall sensor systems of an electro-hydraulic motor vehicle brake system.

### DETAILED DESCRIPTION OF THE PREFERRED EMBODIMENTS

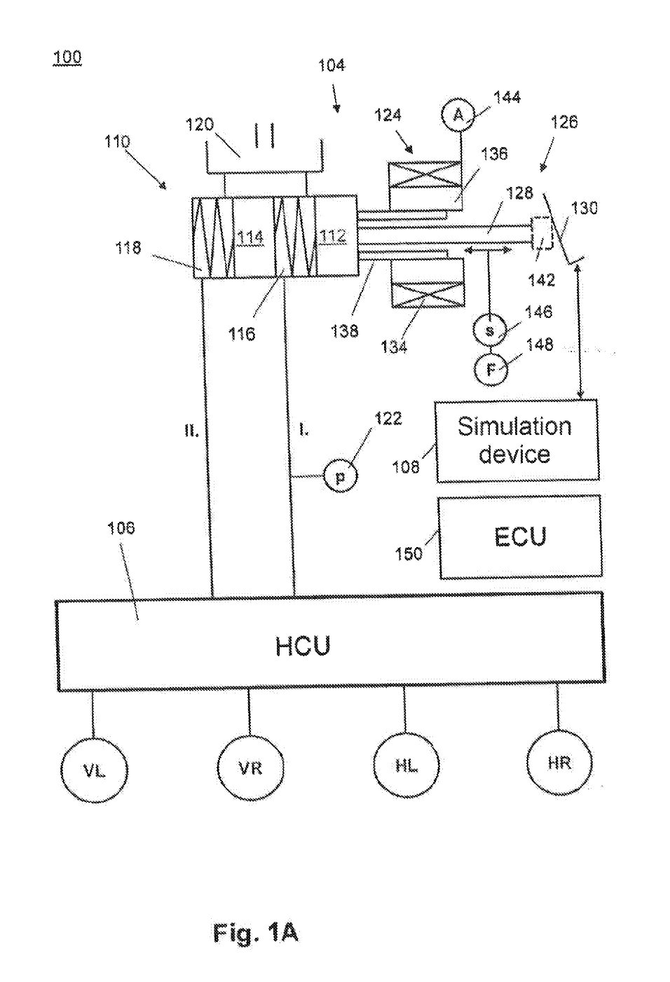

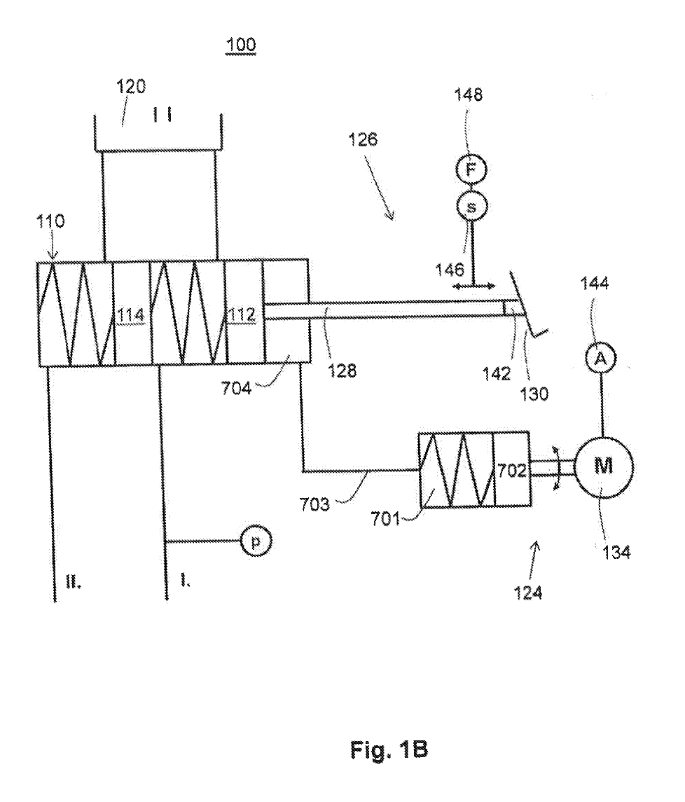

FIG. 1A shows a first exemplary embodiment of a hydraulic motor vehicle brake system 100 which is to be calibrated and which is based on the BBW principle. The brake system 100 can be operated optionally (for example in the case of hybrid vehicles) in a regenerative mode. For this purpose, an electric machine can be provided which provides a generator functionality and can be connected selectively with wheels and an energy store, for example a battery.

As is illustrated in FIG. 1A, the brake system 100 comprises a master cylinder assembly 104 which can be mounted on a vehicle bulkhead. A hydraulic control unit (HCU) 106 of the brake system 100 is arranged functionally between the master cylinder assembly 104 and four wheel brakes, FL, FR, RL and RR of the vehicle. The HCU 106 is embodied as an integrated assembly and comprises a multiplicity of hydraulic individual components as well as a plurality of fluid inlets and fluid outlets. In addition, a simulation device 108 (illustrated only schematically) for making available a pedal reaction behavior is provided in the service brake mode. The simulation device 108 can be based on a mechanical or hydraulic principle. In the last-mentioned case, the simulation device 108 can be connected to the HCU 106.

The master cylinder assembly 104 has a master cylinder 110 with a piston which is accommodated displaceably therein. The piston is embodied in the exemplary embodiment as a tandem piston with a primary piston 112 and a secondary piston 114 and defines, in the master cylinder 110, two hydraulic chambers 116, 118 which are separated from one another. The two hydraulic chambers 116, 118 of the master cylinder 110 are connected to a pressureless hydraulic fluid reservoir 120, in each case via a connection, in order to supply hydraulic fluid. Each of the two hydraulic chambers 116, 116 is also coupled to the HCU 106 and respectively defines a brake circuit I and II. A hydraulic pressure sensor 122, which could also be integrated into the HCU 106, is provided in the exemplary embodiment for the brake circuit I.

The hydraulic assembly 104 also comprises an electromechanical actuator (i.e. an electromechanical actuator element) 124 and a mechanical actuator (i.e. a mechanical actuator element) 126. Both the electromechanical actuator 124 and the mechanical actuator 126 permit activation of the master cylinder piston and for this purpose act on an input-side end face of this piston, to be more precise of the primary piston 112. The actuators 124, 126 are embodied in such a way that they are capable of activating the master cylinder piston independently of one another (and separately or jointly).

The mechanical actuator 126 has a force transmitting element 128 which is embodied in the form of a rod and is capable of acting directly on the input-side end face of the primary piston 112. As shown in FIG. 1A, the force transmitting element 128 is coupled to a brake pedal 130 via a pedal interface (not denoted in more detail). Of course, the mechanical actuator 126 can comprise further components which are arranged functionally between the brake pedal 130 and the master cylinder 110. Such further components can be either of a mechanical or hydraulic nature. In the last-mentioned case, the actuator 126 is embodied as a hydraulic-mechanical actuator 126.

The electromechanical actuator 124 has an electric motor 134 which is embodied, for example, in a brushless fashion, and a transmission 136, 138 which follows the electric motor 134 on the output side. In the exemplary embodiment, the transmission is an arrangement composed of a rotatably mounted nut 136 and a spindle 138 which engages with the nut 136 (for example via roller bearings such as balls) and is movable in the axial direction. In other exemplary embodiments, rack and pinion transmissions or other types of transmission can be used.

The electric motor 134 has in the present exemplary embodiment a cylindrical shape and extends concentrically with respect to the force transmitting element 128 of the mechanical actuator 126. To be more precise, the electric motor 134 is arranged radially on the outside with respect to the force transmitting element 128. A rotor (not illustrated) of the electric motor 134 is coupled in a rotationally fixed fashion to the transmission nut 136, in order to cause the latter to rotate. A rotational movement of the nut 136 is transmitted onto the spindle 138 in such a way that axial displacement of the spindle 138 results. The left-hand end side of the spindle 138 in FIG. 1A can move here into abutment (if appropriate via an intermediate element) against the right-hand end side of the primary piston 112 in FIG. 1, and as a consequence of which it can shift the primary piston 112 (together with the secondary piston 114) to the left in FIG. 1A. In addition, the piston arrangement 112, 114 can also be shifted to the left by the force transmitting element 128, extending through the spindle 138 (embodied as a hollow body), of the mechanical actuator 126 in FIG. 1A. Shifting of the piston arrangement 112, 114 in FIG. 1A to the right is brought about by means of the hydraulic pressure prevailing in the hydraulic chambers 116, 118 (when the brake pedal 130 is released and, if appropriate, when the spindle 138 is shifted by the motor to the right).

As shown in FIG. 1A, a decoupling device 142 is provided functionally between the brake pedal 130 and the force transmitting element 128. The decoupling device 142 permits selective decoupling of the brake pedal 130 from the piston arrangement 112, 114 in the master cylinder 110. As is also illustrated in FIG. 1A, a rotational angle sensor 144 is assigned to the electric motor 134. The rotational angle sensor 144 can be used, for example, in conjunction with the actuation of the electric motor 134.

The method of functioning of the decoupling device 142 and of the simulation device 108 will be explained in more detail below. In this context, it is to be noted that the brake system 100 illustrated in FIG. 1A is based on the BBW principle. This means that within the scope of a normal service braking operation both the decoupling device 142 and the simulation device 108 are activated. Accordingly, the brake pedal 130 is decoupled from the force transmitting element 128 (and therefore from the piston arrangement 112, 114 in the master cylinder 110) by means of a gap (not illustrated in FIG. 1A), and the piston arrangement 112, 114 can be activated exclusively via the electromechanical actuator 124. The accustomed pedal reaction behavior is made available in this case by the simulation device 108 which is coupled to the brake pedal 130.

Within the scope of the service braking operation, the electromechanic actuator 124 therefore performs the brake-force generating function. A braking force which is requested by depressing the brake pedal 130 is generated here by virtue of the fact that the spindle 138 is shifted to the left in FIG. 1A by means of the electric motor 134, and as a result the primary piston 112 and the secondary piston 114 of the master cylinder 110 are also moved to the left. In this way, hydraulic fluid is fed from the hydraulic chambers 116, 118 to the wheel brakes FL, FR, RL and RR via the HCU 106.

The level of the resulting braking force of the wheel brakes FL, FR, RL and RR is set as a function of a brake pedal activation detected by sensor. For this purpose, a travel sensor 146 and a force sensor 148, whose output signals are evaluated by a control unit (Electronic Control Unit, ECU) 150 which actuates the electric motor 134, are provided. The travel sensor 146 detects activation travel which is associated with activation of the brake pedal 130, while the force sensor 148 detects an activation force which is associated with said activation travel. An actuation signal for the electric motor 134 is generated by the control unit 150 as a function of the output signal of at least one of the sensors 146, 148 (and, if appropriate, of the pressure sensor 122). The generation of the actuation signal can also take into account an output signal of the rotational angle sensor 144.

In the present exemplary embodiment, the actuation of the electric motor 134 (and therefore of the electro mechanical actuator 124) takes place in such a way that the length of the gap mentioned at the beginning, for decoupling the brake pedal 130 from the master cylinder-piston arrangement 112, 114, has a dependence on the pedal travel of the brake pedal 130. The dependence is selected in such a way that the gap length increases with a depression of the brake pedal 130 (that is to say with increasing pedal travel). For this purpose, the control unit 150 evaluates the output signal of the travel sensor 146 (and additionally or alternatively that of the force sensor 148) and actuates the electromechanical actuator 124 in such a way that the piston arrangement 112, 114 is moved more quickly to the left in FIG. 1A when the brake pedal 130 is depressed, than a brake-pedal-side limitation of the gap lags with respect to the piston arrangement 112, 114. Correct actuation of the electric motor 134 can be checked with the rotational angle sensor 144. The rotational angle can therefore be integrated in order to determine the number of revolutions of the electric motor. When the characteristic curve of the transmission 136, 138 which is connected downstream of the electric motor 134 is known it is in turn possible to infer the travel carried out by the spindle 138 from the number of revolutions.

After the processes during a service braking mode (BBW mode) have been explained in more detail, the “Push-Through”, PT mode in the case of emergency braking mode will now be described briefly. The emergency braking operation is, for example, the consequence of the failure of the vehicle battery or of a component of the electromechanical actuator 124. Deactivation of the decoupling device 142 (and of the simulation device 108) in the emergency braking mode permits direct coupling of the brake pedal 130 to the master cylinder 110, specifically via the force transmitting element 128.

The emergency braking operation is initiated by depressing the brake pedal 130. The brake pedal activation is then transmitted via the force transmitting element 128 to the master cylinder 110 while overcoming the gap mentioned at the beginning As a consequence, the piston arrangement 112, 114 is shifted to the left in FIG. 1A. As a result, in order to generate braking force, hydraulic fluid is fed from the hydraulic chambers 116, 118 of the master cylinder 110 to the wheel brakes FL, FR, RL and RR via the HCU 106.

FIG. 1B shows a further exemplary embodiment of a motor vehicle brake system 100 which is based on another functional principle from that exemplary embodiment shown in FIG. 1A. Identical or similar elements have been provided with the same reference symbols as in FIG. 1A, and they will not be explained below. For the sake of clarity, a number of elements from FIG. 1A have been omitted.

As shown in FIG. 1B, in the exemplary embodiment according to FIG. 1B the electric motor 134 does not act directly on the primary piston 112 via a mechanical transmission but rather via a hydraulic principle. For this purpose, a separate arrangement composed of a hydraulic cylinder 701 and a piston 702 is provided, wherein the cylinder 701 is hydraulically coupled to an input chamber 704 of the master cylinder 110 via a fluid line 703. The piston 702 in the cylinder 701 can be activated by the electric motor 134 by means of a transmission (illustrated only schematically) in order to feed hydraulic fluid from the cylinder 701 into the inlet chamber 704 of the master cylinder 110 (or vice versa). The resulting change in hydraulic pressure in the inlet chamber 704 brings about a shifting of the primary piston 112 and of the secondary piston 114 in the master cylinder 110 and therefore a change in the brake pressure in the brake circuits I and II.

In the exemplary embodiment according to FIG. 1B, the mechanical actuator 126 is also decoupled from the primary piston 112 in the BBW mode via a gap (not illustrated). The length of the gap is dependent on the actuation travel of the brake cylinder 130.

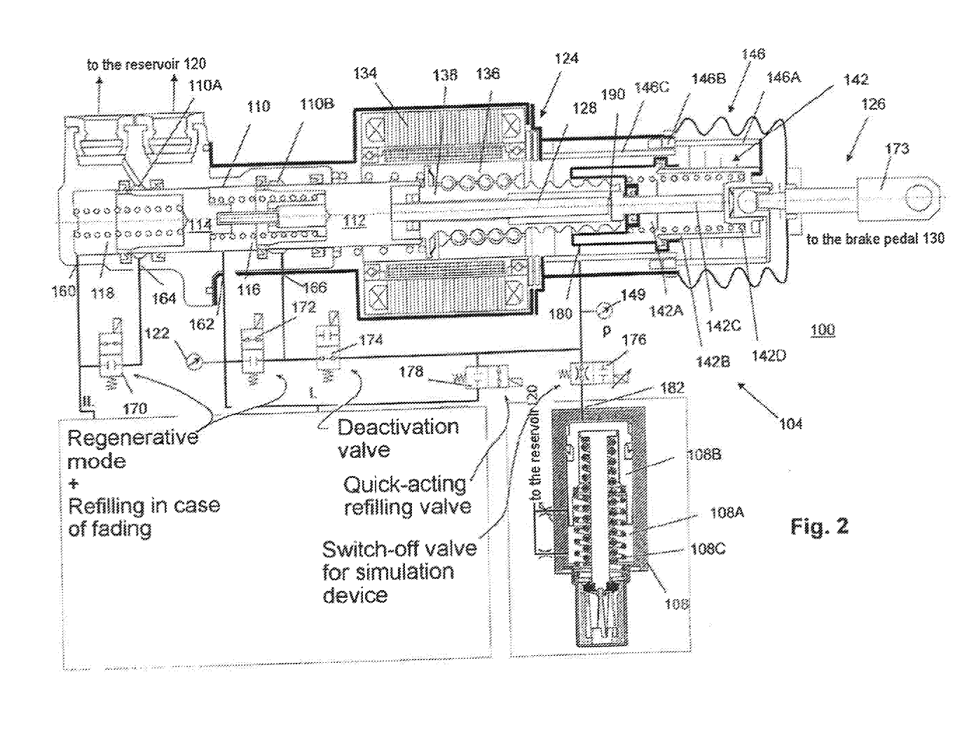

FIG. 2 shows a detailed exemplary embodiment of a motor vehicle brake system 100 which is based on the functional principle explained in conjunction with the schematic exemplary embodiment in FIG. 1A. Identical or similar elements have been provided here with the same reference symbols as in FIG. 1A, and they will not be explained below. For the sake of clarity, the ECU, the wheel brakes and the valve units, assigned to the wheel brakes, of the HCU have not been illustrated.

The vehicle brake system 100 which is illustrated in FIG. 2 also comprises two brake circuits I and II, wherein two hydraulic chambers 116, 118 of a master cylinder 110 are each in turn assigned to precisely one brake circuit I, II. The master cylinder 110 has two connections per brake circuit I, II. The two hydraulic chambers 116, 118 each open here into a first connection 160, 162, via which hydraulic fluid can be fed from the respective chamber 116, 118 into the assigned brake circuit I, II. In addition, each of the brake circuits I and II can be connected via, in each case, a second connection 164, 166, which opens into a corresponding annular chamber 110A, 110B in the master cylinder 110, to the pressureless hydraulic fluid reservoir (reference symbol 120 in FIG. 1A) which is not illustrated in FIG. 2.

Between the respective first connection 160, 162 and the respective second connection 164, 166 of the master cylinder 110 in each case a valve 170,172 is provided which is implemented in the exemplary embodiment as a 2/2-way valve. The first and second connections 160, 162, 164, 166 can be selectively connected to one another by means of the valves 170, 172. This corresponds to a “hydraulic short-circuit” between the master cylinder 110 on the one hand and the pressureless hydraulic fluid reservoir on the other (which hydraulic fluid reservoir is then connected to the hydraulic chambers 116, 118 via the annular chambers 110A, 110B). In this state, the pistons 112, 114 in the master cylinder 110 can be shifted essentially free of resistance by the electromechanical actuator 124 or the mechanical actuator 126 (“release of idle travel”). The two valves 170, 172 therefore, for example, permit a regenerative braking mode (generator mode). Here, the hydraulic fluid expelled from the hydraulic chambers 116, 118 during a delivery movement in the master cylinder 110 is then not directed to the wheel brakes but instead to the pressureless hydraulic fluid reservoir without the occurrence of a buildup of hydraulic pressure (generally undesired in the regenerative braking mode) at the wheel brakes.

The two valves 170, 172 also permit the reduction of hydraulic pressure at the wheel brakes. Such a pressure reduction can be desired in the event of failure (for example blocking) of the electromechanical actuator 124, or in the vehicle movement dynamics control mode in order to avoid a return stroke of the electromechanical actuator 124 (for example in order to avoid a reaction on the brake pedal). The two valves 170, 172 are also transferred into their opened position in order to reduce pressure, as a result of which hydraulic fluid can flow back from the wheel brakes into the hydraulic fluid reservoir via the annular chambers 110A, 110B in the master cylinder 110.

Finally, the valves 170, 172 also permit the hydraulic chambers 116, 118 to be refilled. Such refilling can be necessary during an ongoing braking process (for example owing to what is referred to as brake “fading”). In order to perform refilling, the wheel brakes are fluidically disconnected from the hydraulic chambers 116, 118 by means of assigned valves of the HCU (not illustrated in FIG. 2). The hydraulic pressure prevailing in the wheel brakes is therefore also “shut in”. Subsequently, the valves 170, 172 are opened. During a subsequent return stroke (to the right in FIG. 2) of the pistons 112, 114 provided in the master cylinder 110, hydraulic fluid is then sucked out of the pressureless reservoir into the chambers 116, 118. Finally, the valves 170, 172 can be closed again and the hydraulic connections to the wheel brakes are opened again. During a subsequent feed stroke of the pistons 112, 114 (to the left in FIG. 2), the previously “shut-in” hydraulic pressure can then be increased again.

As is shown in FIG. 2, in the present exemplary embodiment, both the simulation device 108 and the decoupling device 142 are based on a hydraulic principle. The two devices 108, 142 each comprise a cylinder 108A, 142A for accommodating hydraulic fluid and a piston 108B, 142B which is accommodated in the respective cylinder 108A, 142A. The piston 142B of the decoupling device 142 is mechanically coupled via a pedal interface 173 to a brake pedal which is not illustrated in FIG. 2 (cf. reference symbol 130 in FIGS. 1A and 2). In addition, the piston 142B has an extension 142C which extends through the cylinder 142A in the axial direction. The piston extension 142C runs coaxially with respect to a force transmitting element 128 for the primary piston 112 and is mounted ahead of the latter in the activation direction of the brake pedal.

Each of the two pistons 108B, 142B is prestressed into its home position by an elastic element 108C, 142D (a helical spring in each case here). The characteristic curve of the elastic element 108C of the simulation device 108 defines the desired pedal reaction behavior here.

As is also shown in FIG. 2, the vehicle brake system 100 comprises, in the present exemplary embodiment, three further valves 174, 176, 178 which are implemented here as 2/2-way valves. Of course, some or all of these three valves 174, 176, 178 can be eliminated in other embodiments in which the corresponding functionalities are not necessary.

The first valve 174 is provided, on the one hand, between the decoupling device 142 (via a connection 180 provided in the cylinder 142A) and the simulation device 108 (via a connection 182 provided in the cylinder 108A) and, on the other hand, the pressureless hydraulic fluid reservoir (via the connection 166 of the master cylinder 110). The second valve 176 is connected ahead of the connection 182 of the cylinder 108A and has a throttle characteristic in its through-flow position. This valve 176 has a predefined or adjustable throttle function. For example a hysteresis or some other type of characteristic curve for the pedal reaction behavior can be achieved by means of the adjustable throttle function. In addition, by selectively shutting off the valve 176 it is possible to limit the movement of the piston 142B (in the case of closed valves 174, 178) and therefore the brake pedal travel. Finally, the third valve 178 is provided between the hydraulic chamber 116 (via the connection 116) and the brake circuit I, on the one hand, and the cylinder 142A of the decoupling device 142 (via the connection 180), on the other. The third valve 178 permits, in its opened position, the feeding of hydraulic fluid from the piston 142A into the brake circuit I or into the hydraulic chamber 116 of the master cylinder 110, and vice versa.

The first valve 174 permits selective activation and deactivation of the decoupling device 142 (and indirectly also of the simulation device 108). If the valve 174 is in its opened position, the cylinder 142A of the decoupling device 142 is hydraulically connected to the pressureless hydraulic reservoir. In this position, the decoupling device 142 is deactivated in accordance with the emergency braking mode. In addition, the simulation device 108 is also deactivated.

The opening of the valve 174 has the effect that when the piston 142B is shifted (owing to activation of the brake pedal), the hydraulic fluid accommodated in the cylinder 142A can be fed largely without resistance into the pressureless hydraulic fluid reservoir. This process is essentially independent of the position of the valve 176, since the latter also has a significant throttling effect in its opened position. Therefore, in the open position of the valve 174 the simulation device 108 is also deactivated indirectly.

In the case of brake pedal activation in the opened state of the valve 174, the piston extension 142C overcomes a gap 190 with respect to the force transmitting element 128 and as a result moves into abutment against the force transmitting element 128. After the gap 190 has been overcome, the force transmitting element 128 is affected by the shifting of the piston extension 142C and subsequently activates the primary piston 112 (and, indirectly, the secondary piston 114) in the master brake cylinder 110. This corresponds to the direct coupling of the brake pedal and the master cylinder pistons already explained in conjunction with FIG. 1A, in order to build up hydraulic pressure in the brake circuits I, II in the emergency braking mode.

In contrast, when the valve 174 is closed (and the valve 178 is closed) the decoupling device 142 is activated. This corresponds to the service brake mode. In this case, when the brake pedal is activated, hydraulic fluid is fed from the cylinder 142A into the cylinder 108A of the simulation device 108. In this way, the simulator piston 108B is shifted counter to the opposing force made available by the elastic element 108C, with the result that the accustomed pedal reaction behavior occurs. At the same time, the gap 190 between the piston extension 142C and the force transmitting element 128 continues to be maintained. As a result, the brake pedal is mechanically decoupled from the master cylinder.

In the present exemplary embodiment, the gap 190 is maintained by virtue of the fact that by means of the electromechanical actuator 124 the primary piston 112 is moved to the left at least as quickly in FIG. 2 as the piston 142B is moved to the left on the basis of the brake pedal activation. Since the force transmitting element 128 is coupled mechanically or in some other way (for example magnetically) to the primary piston 112, the force transmitting element 128 moves together with the primary piston 112 when it is activated by means of the transmission spindle 138. This entrainment of the force transmitting element 128 permits the gap 190 to be maintained.

Maintaining the gap 190 in the service brake mode requires precise detection of the travel carried out by the piston 142B (and therefore the pedal travel). For this purpose a travel sensor 146 which is based on a magnetic principle is provided. The travel sensor 146 comprises a plunger 146A which is rigidly coupled to the piston 142B and at whose end a magnet element 146B is mounted. The movement of the magnet element 146B (i.e. the travel carried out by the plunger 146B or piston 142B) is detected by means of a Hall sensor 146C. An output signal of the Hall sensor 146C is evaluated by a control unit (cf. reference symbols 150 in FIG. 1) not shown in FIG. 2. The electromechanical actuator 124 can then be actuated on the basis of this evaluation.

In a hydraulic line which opens into the connection 180 of the cylinder 142A, a pressure sensor 149 is provided whose output signal permits a conclusion to be drawn about the activation force at the brake pedal. The output signal of this pressure sensor 149 is evaluated by a control unit which is not shown in FIG. 2. On the basis of this evaluation, one or more of the valves 170, 172, 174, 176, 178 can then be actuated in order to implement the functionalities described above. In addition, the electromechanical actuator 124 can be actuated on the basis of this evaluation.

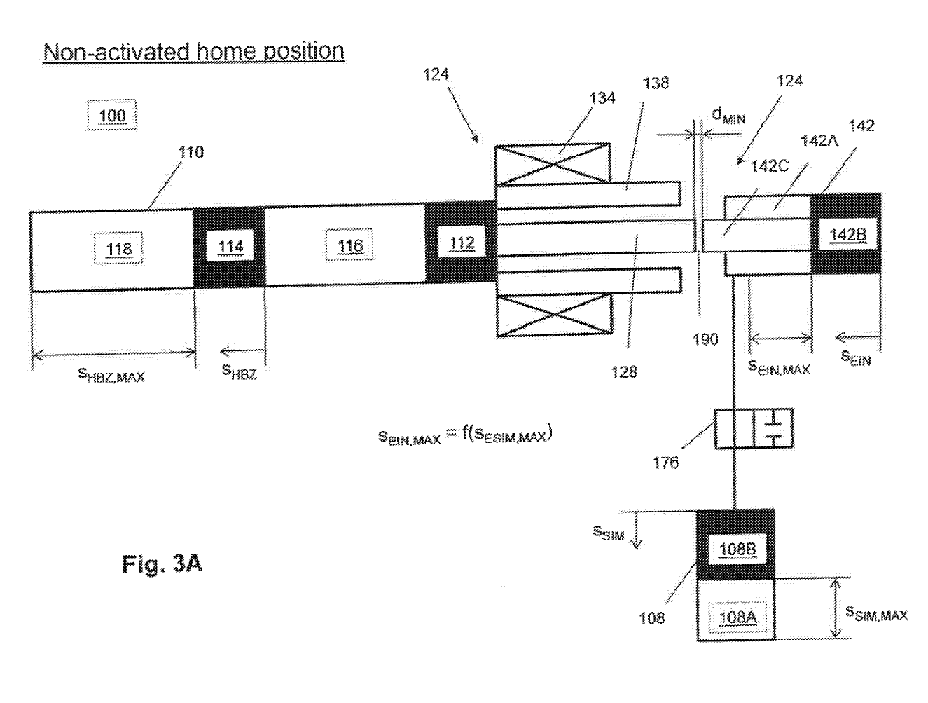

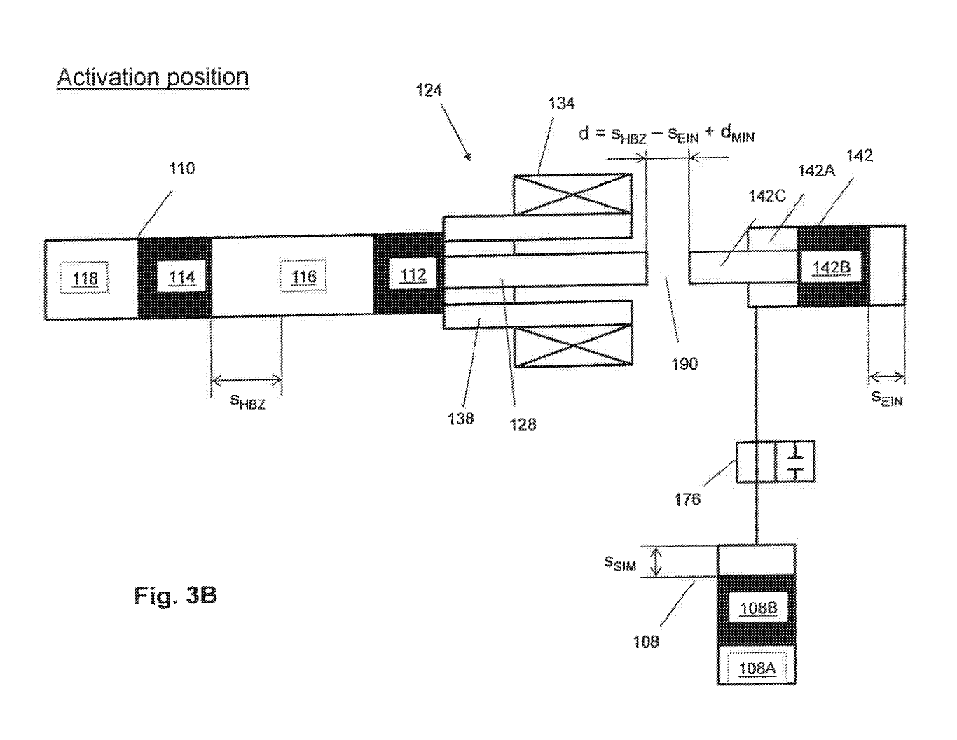

In the exemplary embodiment according to FIG. 2, there is also pedal travel dependence of the gap 190 between the force transmitting element 128, on the one hand, and the piston extension 142C on the other. The processes during the activation of the brake system 100 FIG. 2 will be explained in more detail in respect of the travel dependence of a length d of the gap 190 (“gap length d”) with reference to the schematic FIGS. 3A and 3B. Of course, the corresponding technical details can also be implemented in the brake systems 100 according to FIGS. 1A and 1B.

FIGS. 3A and 3B illustrate the components of the brake system 100 according to FIG. 2 which are decisive for explanation of the travel dependence of the gap length d. FIG. 3A illustrates here the non-activated home position of the brake system 100 in the BBW mode (that is to say when the brake pedal is not activated), while FIG. 3B shows the activation position in the BBW mode.

As illustrated in FIG. 3A, the gap 190 is formed between end faces, facing one another, of the force transmitting element 128, on the one hand, and of the piston extension 142C, on the other. In the non-activated basic state according to FIG. 3A, the gap length d has a predefined minimum value d_{MIN} of approximately 1 mm.

In the case of activation of the brake pedal, the piston 142B in the cylinder 142A in FIG. 3A is shifted to the left and carries out travel S_{EIN}. In the BBW mode the valve 176 between the cylinder 142A and the cylinder 108A of the simulation device 108 is normally opened here. The hydraulic fluid which is expelled from the chamber 142A when the piston 142B is shifted can therefore be forced into the cylinder 108A and in the process shifts the piston 108B in FIG. 3A downward counter to a spring force (cf. element 108C in FIG. 2). This spring force brings about the pedal reaction behavior with which the driver is familiar.

The travel S_{EIN} which the piston 142B can carry out in the cylinder 142A in the case of a brake pedal activation, is limited to a maximum value S_{EIN,MAX} of typically 10 to 20 mm (for example approximately 16 mm). This limitation also brings about limitation of the brake pedal travel.

In the exemplary embodiment according to FIG. 3A, the limitation to the maximum value S_{EIN,MAX} is obtained owing to a stop in the cylinder 108A for the cylinder 108B which limits the travel S_{SIM} of the piston 108A to a maximum value S_{SIM,MAX}. Between the maximum values S_{EIN,MAX} and S_{SIM,MAX} there is a functional relationship which is predefined by the volume of hydraulic fluid which is shifted between the two cylinders 142A, 108A, and the hydraulically effective working areas of the two cylinders 142B, 108B.

As already explained above, there is the possibility of limiting the travel S_{EIN} to a smaller maximum value than that defined by S_{SIM,MAX}. This limitation is carried out by closing the valve 176 before the piston 108B reaches its stop in the cylinder 108A (it is assumed here that the hydraulic fluid which is expelled from the cylinder 142A cannot escape in other ways, that is to say for example the valves 174, 178 in FIG. 2 are closed). The limitation of the travel S_{EIN} by closing the valve 176 therefore limits the pedal travel. Such pedal travel limitation is performed in the present exemplary embodiment when an ABS control system starts.

When the brake pedal is activated in the BBW mode, the electromechanical actuator 124 is actuated in order to act on the primary cylinder 112 in the master cylinder 110 by means of the spindle 138 and therefore also on the secondary piston 114. The piston arrangement 112, 114 subsequently shifts to the left by travel S_{HBZ} in FIG. 3A (or to the right when the brake pedal is released). The travel S_{HBZ} is also limited to a maximum value S_{HBZ,MAX} of approximately 35 to 50 mm (for example approximately 42 mm). This limitation occurs on the basis of a stop in the master cylinder 110 for at least one of the two pistons 112, 114.

As already stated above, the force transmitting element 128 is fixedly or releasably coupled (for example by means of magnetic forces) to the primary piston 112 in a mechanical fashion. Shifting of the primary piston 112 (and the secondary piston 114) in the master cylinder 110 therefore brings about the same shifting of the force transmitting element 128 in terms of direction and travel.

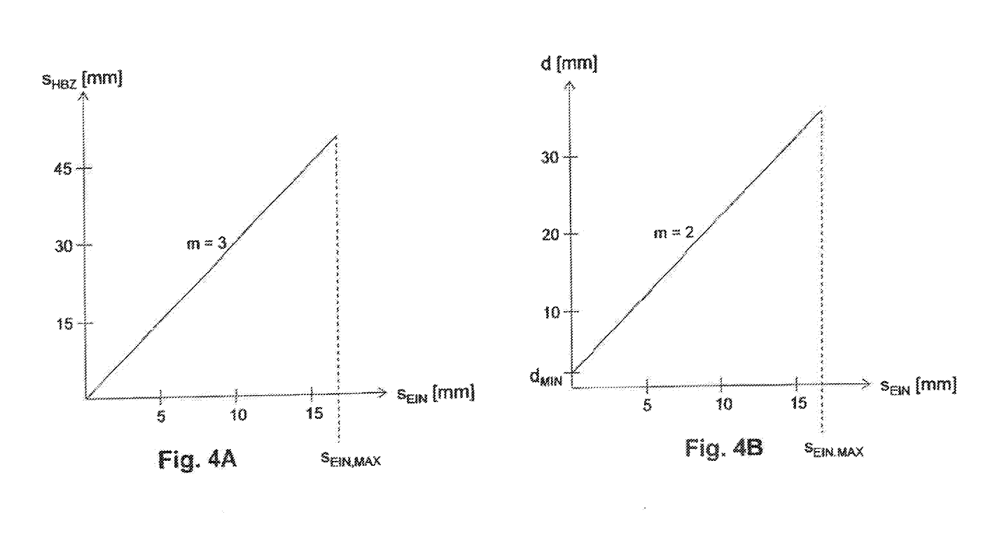

The actuation of the electromechanical actuator 124 takes place then in such a way that a specific transmission ratio is defined between S_{EIN} and S_{HBZ}. The transmission ratio in the exemplary embodiment is selected to be >1 and is, for example 1:3 (cf. FIG. 4A). Owing to the rigid coupling of the force transmitting element 128 to the primary piston 112 as well as of the piston extension 142C to the piston 142B, the same transmission ratio is set between travel which is carried out by the end face of the piston extension 142C facing the force transmitting element 128 and travel carried out by an end face of the force transmitting element 128 associated with the piston extension 142C.

The transmission ratio is consequently selected in such a way that the gap length d increases continuously as the brake pedal is depressed. This ensures that the force transmitting element 138 moves more quickly to the left in FIG. 3B than the piston extension 142C follows it. It is therefore possible to speak here of transmission between the travel S_{EIN} of the piston 142B on the gap length d, wherein the transmission ratio is, as shown in FIG. 4B, approximately 2 (and can generally be between 1:1.5 and 1:4.

The gap length d which increases as the brake pedal is depressed is advantageous for reasons of safety, since as the brake pedal travel increases relatively “strong” mechanical decoupling of the brake pedal from the piston arrangement 112, 114 is achieved in the master cylinder 110.

In the above exemplary embodiments, the gap 190 is provided between the force transmitting element 128 and the piston extension 142C. It is to be noted that in other embodiments the gap could also be provided at another point in the force transmitting path between the brake pedal 130 and the master cylinder-piston arrangement 112, 114. For example, it is conceivable to embody the piston extension 142C and the force transmitting element 128 as a single, gap-free component. In this case, a gap could then be provided between the end face of the primary piston 112 facing the brake pedal and the end face of the integrated element 128, 142C facing the primary piston 112.

As is apparent from the above explanation, precise position measurement of the piston 142B by means of the Hall sensor system 146B, 146C is highly significant for the functional capability of the brake system 100 which is illustrated in FIGS. 1A, 1B and 2, in order to be able to implement the activation travel dependence of the width of the gap 190, illustrated in FIGS. 4A and 4B. In the text which follows a calibration method for the Hall sensor system 146B, 146C is explained on the basis of an output signal of the rotational angle sensor 144 which is provided for the electric motor 134. At this point it is already to be noted that instead of the Hall sensor system 146B, 146C, the force sensor 148 or the pressure sensor 149 (cf. FIGS. 1A, 1B and 2) could also be calibrated in a similar way. During the calibration of the corresponding sensor systems 146, 148, 149, the corresponding sensor signal is referred in the following exemplary embodiment to travel which has been determined on the basis of a signal of the rotational angle sensor 144. It is to be noted that in other exemplary embodiments the output signals of the sensor systems 146, 148, 149 could also be referred to other physical variables.

The calibration of the brake system 100 can take place before the installation in a motor vehicle or in the installed state. According to the variant described below, the calibration takes place within the scope of an end-of-line test before the installation of the brake system 100 in a motor vehicle. In the case of the exemplary embodiment according to FIG. 1A and FIG. 2, the brake system 100 and, in particular, the hydraulic chambers 116, 118, are not filled with hydraulic fluid during the calibration. The calibration therefore takes place in the “dry” state of the brake system 100. In the case of the exemplary embodiment according to FIG. 1B, at least the hydraulic circuit provided ahead of the primary piston 112 (cylinder 701, hydraulic line 703 and input chamber 704) is filled hydraulic fluid.

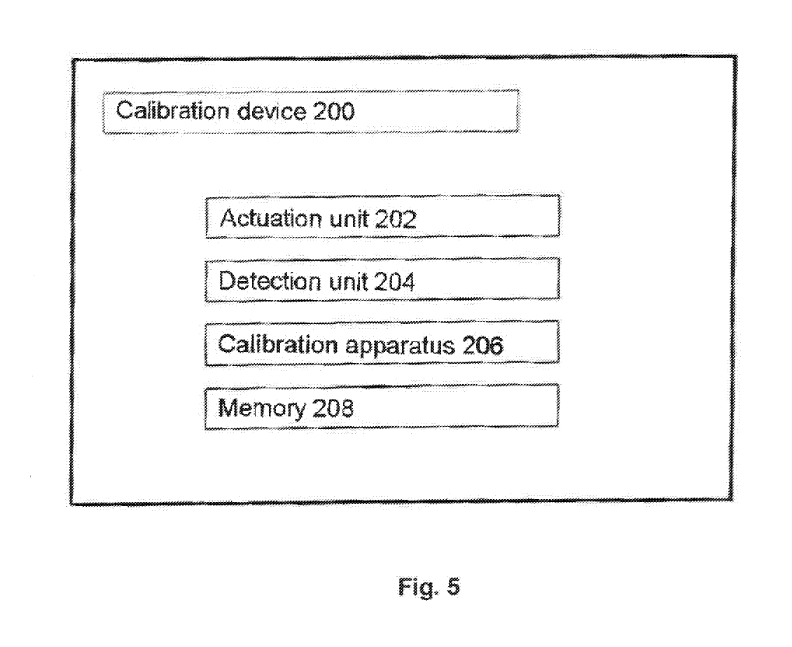

FIG. 5 shows an exemplary embodiment of a calibration device 200 for the brake system 100 according to FIGS. 1A, 1B and 2. The calibration device 200 can be part of a diagnostic device or of some other test device.

As shown in FIG. 5, the calibration device 200 comprises an actuation unit 202, a detection unit 204, a calibration apparatus 206 and a memory 208.

The actuation unit 202 is designed to actuate the electric motor 134 in order to activate the piston accommodated in the master cylinder 110 (i.e. the primary piston 12 and the secondary piston 114). For this purpose, the actuation unit 202 is connected either directly to the electric motor 134 or else to the control unit 150 provided for the electric motor 134 (cf. FIG. 1A).

The detection unit 204 is electrically coupled to those sensor systems of the brake system 100 which are to be considered for the respective calibration process. In the following exemplary embodiment, the detection unit 204 is electrically coupled to the rotational angle sensor 144, on the one hand, and to the Hall sensor 146C, on the other.

The calibration apparatus 206 is designed to carry out calibration on the basis of the sensor signals detected by the detection unit 204. The result of calibration can then be stored in the form of data in a control unit of the brake system 100, for example in the control unit 150 illustrated in FIG. 1A. In addition, buffering of the calibration result in the memory 208 of the calibration device 200 is possible. The memory 208 also serves to store at least temporarily the signals detected by the detection unit 204. The calibration apparatus 206 can then access the signals stored in the memory 208 by the detection unit 204.

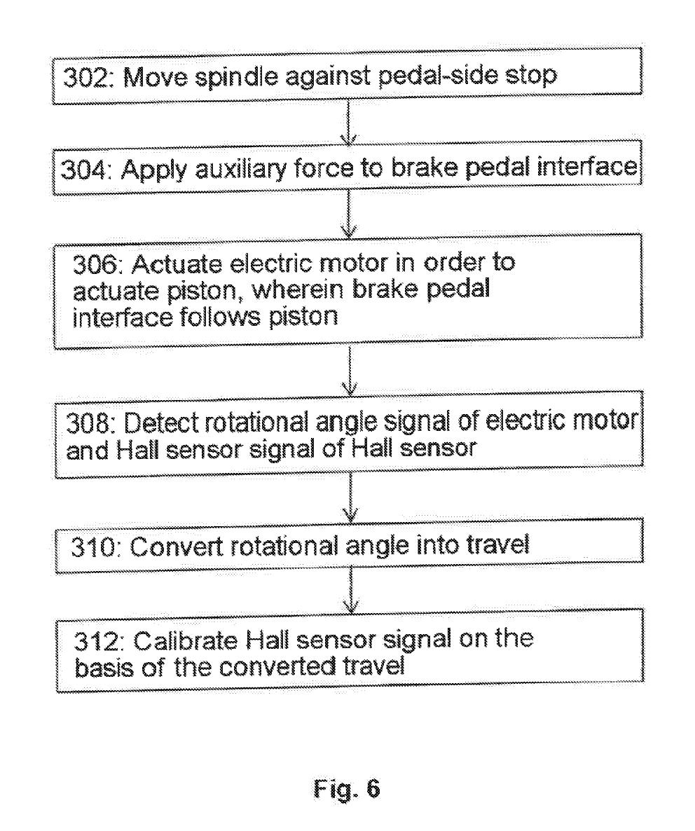

In the text which follows, the calibration method which is carried out by means of the calibration device 200 will be explained in more detail with reference to the exemplary embodiment according to FIG. 2 and the flowchart illustrated in FIG. 6.

In a first step 302, the electric motor 134 is actuated by the actuation unit 202 in such a way that the spindle 138 is moved against its pedal-side stop. Step 302 permits utilization of the maximum available piston stroke.

In a subsequent step 304, an auxiliary force is then applied to the piston 142B which is coupled to the brake pedal 130 (or to the brake pedal interface 173 illustrated in FIG. 2). This auxiliary force causes the piston 142B to move, together with the piston extension 142B, into abutment against the actuation element 128 by overcoming the gap 190. The piston 142B is therefore mechanically coupled to the primary piston 112 and can follow shifting of the piston 112 to the left in FIG. 2 (and to the right) under the effect of the auxiliary force. The plunger 146A, which is rigidly coupled to the piston 142B and supports the magnet element 146B, is also affected by this follow-on movement. The lagging of the piston 142B during shifting of the primary piston 112 to the left in FIG. 2 is therefore transmitted directly to the magnet element 146B and can be correspondingly detected by the Hall sensor 146C.

In a further step 306, the electric motor 134 is actuated by the actuation unit 202 in such a way that the primary piston 112 and the secondary piston 114 are moved slowly to their stop which is on the left in FIG. 2. The travel of approximately 40 mm which is carried out by the primary piston 112 here is executed in approximately 15 seconds. Owing to the auxiliary force applied to the piston 142B, the piston 142B (and therefore the magnet element 146B mounted on the plunger 146A) directly follows, as stated above, the movement of the primary piston 112.

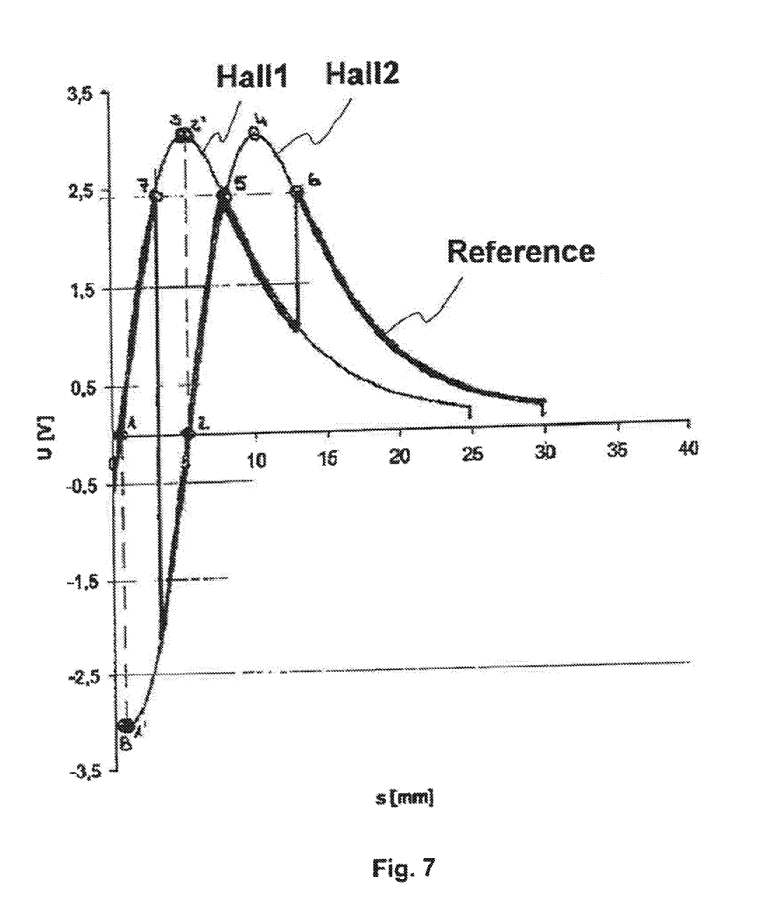

During the piston activation as a result of the activation step 306 pairs of signal levels or signal values of the rotational speed sensor 144, on the one hand, and of the Hall sensor 146C, on the other, are continuously detected by the detection unit 204 and stored together in the memory 208 (step 308 in FIG. 6). Owing to the known characteristic curve of the transmission (cf. reference symbol 136/138 in FIG. 2), the extent of the piston activation, to be more precise the travel carried out by the primary piston 112, can be determined by integrating the rotational angle signal supplied by the rotational angle sensor 144. The value pair which is detected at a certain time and is composed of the travel carried out by the primary piston 112 (as calculated on the basis of the rotational angle), on the one hand, and the output voltage of the Hall sensor 146C, corresponding to this travel, on the other, then permits travel calibration of the Hall sensor 146C according to step 312, since the magnet element 146B carries out the same travel as the primary piston 112. The characteristic curve which results from this calibration and which has been determined from a multiplicity of corresponding value pairs is illustrated in FIG. 7. To be more precise, FIG. 7 shows the characteristic curves of two Hall sensors 146C (since in the case of the brake system according to FIG. 2 two Hall sensor systems which are arranged offset in the axial direction are installed for reasons of accuracy).

FIG. 7 illustrates characteristic curves which are arranged offset with respect to one another, as have been determined by the calibration apparatus 206 in step 312 on the basis of the value pairs detected by the detection unit 204 for each Hall sensor system. The x axis corresponds here to the signal of the rotational angle sensor 144 in mm which has been converted to the travel carried out by the primary piston 112. The y axis denotes the output signal of the respective Hall sensor 146C in volts. The non-linear characteristic of the respective output signal of the Hall sensors 146C is clearly apparent, which conventionally makes calibration difficult.

The reference line shown in bold in FIG. 7 denotes the part of the two characteristic curves which has an approximately linear profile in each case. The reference line is used for the determination of the activation travel, carried out by the brake pedal 130, in the BBW mode of the brake system 100.

Since a certain degree of hysteresis of the Hall sensor systems with respect to a movement in FIG. 2 to the left, on the one hand, and to the right, on the other, cannot be ruled out, the steps illustrated in FIG. 7 can also be carried out in the case of a return stroke of the primary piston 112 (from left to right in FIG. 2), in order to determine separate characteristic curves for the forward stroke and the return stroke. The primary piston 112 and the secondary piston 114 follow here a movement of the spindle 138 to the right in FIG. 2 owing to the spring forces acting on them.

It is to be noted that the calibration method explained above can also be used in the brake system 100 according to FIG. 1B. In order to determine the travel carried out by the primary piston 112 (and therefore the mechanical actuator 126) on the basis of the output signal of the rotational angle sensor 144, it would then also be necessary to take into account additionally the transmission ratio between the piston 702 and the primary piston 112.

The calibration method presented here permits precise calibration of the travel for the Hall-based travel sensor 146 within the scope of an end-of-line test or in some other way. Equally, calibration of the travel for the force sensor 148 or the pressure sensor 149 could be carried out. In practice, it has become apparent that the calibration of the travel is advantageous in particular for Hall sensor systems owing to their strongly non-linear characteristic.

In addition, the calibration method described here permits calibration of the maximum piston stroke for each brake system 100. The calibration of the maximum stroke is carried out by integrating the output signal of the rotational angle sensor during the movement of the primary piston 112 between its two stops. The maximum piston stroke is required for reasons of protection of components.

Of course, in different embodiments further or other sensor systems could be calibrated. In addition, the calibration method proposed here could, of course, also be used to calibrate the rotational angle sensor 144 on the basis of the signal of one or more of the sensors 146, 148, 149. It is also to be noted that instead of a rotational angle sensor 144 other sensor types, or additional sensor types, could also be used to detect a change in state of the actuator 124. Examples of this are a Hall sensor for detecting the translational travel of the spindle 138 or a pressure sensor in the cylinder 701, in the fluid line 703 or in the inlet chamber 704 in FIG. 1B.

The principle and mode of operation of this invention have been explained and illustrated in its preferred embodiment. However, it must be understood that this invention may be practiced otherwise than as specifically explained and illustrated without departing from its spirit or scope.

1. A calibration method for an electro-hydraulic motor vehicle brake system which comprises a piston for building up a hydraulic pressure in the brake system, a first actuator having an electric motor and a second actuator having a brake pedal interface, wherein the first actuator and the second actuator are capable of activating the piston, and wherein a first sensor system is capable of detecting a change in state of the first actuator, and a second sensor system is capable of detecting a change in state of the second actuator, the method comprising:
actuating the electric motor in order to activate the piston by means of the first actuator, wherein the second actuator follows the piston activation;
detecting, during the piston activation, a first signal which is generated by the first sensor system and permits a conclusion to be drawn about an extent of the piston activation, as well as a second signal which is generated by the second sensor system; and
calibrating the first signal on the basis of the second signal, or vice versa.

2. The method according to claim 1, wherein during the actuation of the electric motor an auxiliary force is applied to the second actuator, under which auxiliary force the second actuator follows the piston activation.

3. The method according to claim 1, wherein the brake system can be operated in a “brake-by-wire”, BBW, mode; and
a gap is provided or can be provided in a force transmission path between the brake pedal interface and the piston, in order to decouple the second actuator from the piston in the BBW mode.

4. The method according to claim 2, wherein the gap is overcome or formation of the gap is prevented by means of the auxiliary force.

5. The method according to claim 3, wherein
the second sensor system is capable of detecting a change in state of part of the second actuator which part is located on a side of the gap located opposite the piston.

6. The method according to claim 1, wherein a change in the second signal is detected; and
the calibration of the second signal relates the change in the second signal to the extent of the piston activation specified by the first signal.

7. The method according to claim 1, wherein
the first signal has an essentially linear characteristic, the second signal has an essentially non-linear characteristic, and the second signal is calibrated on the basis of the first signal.

8. The method according to claim 1, wherein the piston has a maximum stroke; and
the electric motor is actuated so that the piston essentially executes the maximum stroke.

9. The method according to claim 1, wherein the first signal and the second signal are detected, while the electric motor is actuated in two opposite directions.

10. The method according to claim 1, wherein the electric motor is a brushless motor.

11. The method according to claim 1, wherein the first sensor system detects at least one of the following changes in state:
a change in state of the electric motor;
a change in state of a transmission component which is included in the first actuator and is functionally provided between the electric motor and the piston.

12. The method according to claim 11, wherein
the change in state of the electric motor is specified by at least one of the following parameters:
rotational angle of the electric motor;
number of revolutions of the electric motor.

13. The method according to claim 1, wherein the second sensor system comprises a travel sensor, and the travel sensor is calibrated.

14. The method as claimed in claim 13, wherein
the travel sensor comprises at least one of the following elements:
a Hall sensor;
a magnet;
a potentiometer.

15. The method according to claim 13, wherein
the travel sensor is configured to detect actuation travel of the second actuator or of a part of the second actuator.

16. The method according to claim 15, wherein
the second actuator comprises a brake pedal, and the travel sensor is configured to detect actuation travel of the brake pedal.

17. The method according to claim 1, wherein
the second sensor system comprises a pressure sensor, and the pressure sensor is calibrated.

18. The method according to claim 17, wherein
the second actuator comprises a hydraulic circuit, and the pressure sensor is configured to detect a hydraulic pressure in the hydraulic circuit of the second actuator.

19. The method according to claim 1, wherein the second sensor system comprises a force sensor, and the force sensor is calibrated.

20. The method according to claim 19, wherein
the force sensor is designed to detect a force which is applied to the brake pedal interface by a driver.

21. The method according to claim 1, wherein the method is carried out before the brake system is installed in a motor vehicle.

22. The method according to claim 1, wherein the method is carried out in a state of the brake system which is devoid of hydraulic fluid.

23. A computer program having program code for carrying out the method according to claim 1 when the computer program is executed by a computer device.

24. A calibration device for an electro-hydraulic motor vehicle brake system which comprises a piston for building up a hydraulic pressure in the brake system, a first actuator having an electric motor and a second actuator having a brake pedal interface, wherein the first actuator and the second actuator are capable of activating the piston, and wherein a first sensor system is capable of detecting a change in state of the first actuator, and a second sensor system is capable of detecting a change in state of the second actuator, the device comprising:
an actuation unit which is designed to actuate the electric motor in order to activate the piston by means of the first actuator, wherein the second actuator follows the piston activation;
a detection unit which is designed to detect, during the piston activation, a first signal which is generated by the first sensor system and permits a conclusion to be drawn about an extent of the piston activation, as well as a second signal which is generated by the second sensor system;
a calibration apparatus which is designed to calibrate the first signal on the basis of the second signal, or vice versa.
